(19) United States
(12) Patent Application Publication
(10) Pub. No.: US 2010/0311337 A1
(43) Pub. Date: Dec. 9, 2010

(54) MULTI-MODAL SPEECH HOLSTER

(75) Inventor: Bart RIVIERE, Bredene (BE)

Correspondence Address: Pearne & Gordon LLP, 1801 East 9th Street, Suite 1200, Cleveland, OH, 44114-3108, US

(73) Assignee: PSION TEKLOGIX INC., Mississauga (CA)

(21) Appl. No.: 12/618,337

(22) Filed: Nov. 13, 2009

Related U.S. Application Data
(60) Provisional application No. 61/184,122, filed on Jun. 4, 2009.

(51) Int. Cl. H04B 7/00; H04M 1/00

(52) U.S. Cl. 455/41.3; 455/575.6

(57) ABSTRACT

A wearable holder for a multi-modal mobile computer that connects a mobile computer to a headset for speech-directed operations while the mobile computer is docked in the holder but also allows easy disconnect and reconnect operation when the mobile computer must be removed from the wearable holder for handheld operations.

### FIELD OF INVENTION

The present invention relates to establishing a communication path between an input and/or output (I/O) device and a mobile computer and in particular to establishing a communication path between a headset and a mobile computer capable of voice directions.

### BACKGROUND OF THE INVENTION

Multi-modal mobile computing devices, referred to as mobile computers herein, are used in a variety of settings. A common example of this type of device is used in warehouse applications. In warehouse settings mobile computers that incorporate bar code scanners, RFID scanners, digital cameras, touch keys or other manual input devices, visual displays, and wireless transmitter/receivers in communication with a centralized computer system are often used for inventory management. Such systems often enable real-time inventory management through one or two way communication with mobile operators and may coordinate the actions of individual operators automatically.

Mobile computer systems that make use of speech to provide or receive instructions or data may also be implemented. Operators using these systems can receive spoken instructions from the mobile computer as directed by software resident on the mobile computer, directions from a central system in communication with the mobile computer or other automated means. A mobile computer may also be enabled to receive spoken instructions from the operator. A natural tool to use to establish these speech links is a headset consisting of one or two earphones and optionally including a microphone on a boom or otherwise. The headset in such systems is connected to the mobile computer through the use of electrical wiring in the form of a cable, although other connections, such as wireless connections are possible. Other combinations of equipment are equally suitable for this application including headphones, in-ear buds, and microphones secured to worn articles such as garments or helmets, etc. The mobile computer itself may include microphones and/or speakers although this may create problems in noisy environments.

A mobile computer may offer a wide range of functionality within a convenient handheld housing. The mobile computer may be adapted for use as a handheld scanning device. A handheld mobile computer may be carried in a variety of ways by an operators but it is typically not desirable to require the operator to keep the mobile computer in-hand at all times. A common solution to this problem is to provide operators with a wearable holder such as a holster or pouch to carry the mobile computer. When an operator is required to perform a function, such as scanning, keyboard/touchpad entry, or viewing the screen, the handheld mobile computer is removed from its wearable holder.

When a handheld mobile computer is physically connected by cabling to a headset, the act of removing the mobile computer from its holder requires that the cable be managed in some fashion. Previous cable management solutions have included reels, coils or other similar mechanisms that allow the cable to be extended when the handheld mobile computer is taken out of the holster and retracted when the handheld mobile computer is returned to the holster. Although such cable management solutions to help to reduce the problem of having a loose cable hanging from the handheld mobile computer, such cable management solutions can be cumbersome for the operator. The reel or coils may also break with repeated use requiring replacement.

An alternative to managing the cables connecting the headset to the handheld mobile computer is to provide a wireless connection between the headset and handheld mobile computer. Although the wireless connection does away with connection cables, wireless connections require that the headset include a wireless transceiver and power supply. The wireless connection also requires the handheld mobile computer have a corresponding wireless transceiver. Operating the wireless transceiver of the handheld mobile computer will consume power from the handheld mobile computer, resulting in a lower operating time. Additional the wireless connection of the headset may add additional costs to the headset as well as the handheld mobile computer. The wireless headset may also add additional weight to the headset, which can be a problem for headsets that are worn for long periods of time, such as an 8 hour shift.

### SUMMARY OF THE INVENTION

In accordance with an embodiment of the present disclosure there is provided an apparatus for creating a communication link between an input and/or output (I/O) device and a mobile computer. The apparatus comprises a wearable holder for cradling the mobile computer and a connection adapter coupled to the wearable holder. The connection adapter comprises a docking connector for creating a communication link between the connection adapter and the mobile computer, and a connector jack for establishing a physical connection to the I/O device, the physical connection providing a communication link between the connection adapter and the I/O device. A communication path may be established between the mobile computer when cradled by the wearable holder and the I/O device.

In accordance with another embodiment of the present disclosure there is provided a voice controlled mobile computer system comprising a mobile computer adapted for optically capturing information, processing captured information and providing voice commands to an operator, a headset comprising a cable with a connector at a terminal end and a speaker, the headset capable of outputting the voice commands to the operator, and a wearable holder for cradling the mobile computer. The wearable holder comprises a connection adapter coupled to the wearable holder comprising a docking connector for creating a communication link between the connection adapter and the mobile computer and a connector jack for receiving the connector attached to the cable of the headset and establishing a physical connection to the headset, the physical connection providing a communication link between the connection adapter and the I/O device. The headphones remain connected to the connector jack when the mobile computer is removed from the wearable holder and a communication path is established between the mobile computer and the headset when the mobile computer is cradled by the wearable holder.

In accordance with a further embodiment of the present disclosure there is provided a connection adapter for use with a wearable holder for establishing a communication path between a mobile computer and an Input and/or Output (I/O) device. The connection adapter comprises a docking connector for creating a communication link between the connection adapter and the mobile computer and a connector jack for receiving the connector attached to the cable of the headset and establishing a physical connection to the headset, the physical connection providing a communication link between the connection adapter and the I/O device. A communication is established between the communication link between the connection adapter and the mobile computer and the communication link between the connection adapter and the I/O device.

### BRIEF DESCRIPTION OF THE DRAWINGS

These and other features of the invention will become more apparent from the following description in which reference is made to the appended drawings wherein:

FIGS. 1A and 1B depict schematics of an illustrative speech-controlled mobile computer system;

FIG. 2 depicts in a block diagram another illustrative headset connection adapter;

FIGS. 3A-3D depict in schematics an illustrative embodiment of the wearable holder;

FIG. 4 depicts in a schematic an alternative embodiment to the wearable holder;

FIG. 5 depicts in a process flow chart the use of the voice controlled mobile computer system; and

FIGS. 6A-6D depict schematics of an operator using the voice controlled mobile computing system

### DETAILED DESCRIPTION

In accordance with the present disclosure there is provided a wearable holster for a handheld mobile computer. A headset, or other input and/or output (I/O) device, may be physically connected to the holster, or a component of the holster, providing a communication link between the headset and the holster or component. The holster, or component, further comprises a detachable connector for connecting the holster or component with the mobile computer while it is held in the holster and establishing a communication link between the mobile computer and the holster or component. A communication path is established between the mobile computer and the headset over the communication links established through the holster or component when the mobile computer is held in the holster.

Advantageously, the novel holster described herein, allows a communication path to be established between a headset and a mobile computer when the mobile computer is in the holster. The communication path may be used to transfer information, such as audio data, between the headset and the mobile computer when the mobile computer is held in the holster. The mobile computer may be removed from the holster, which results in the communication path between the mobile computer and the holster, and so the headset, being broken. The mobile computer may then be operated without the connection to the headset, for example scanning a barcode, using a keypad or viewing a display screen. The physical connection between the headset and the holster is maintained, even when the mobile computer is removed from the holster, allowing for the communication path between the mobile computer and the headset to be re-established once the mobile computer is returned to the holster. The holster, as described further herein does not require any additional cable management solutions, such as reels or coils in order to manage the cable connection between the headset and the holster, since the headset is physically connected to the holster and not the mobile computer, which remains free to remove from the holster.

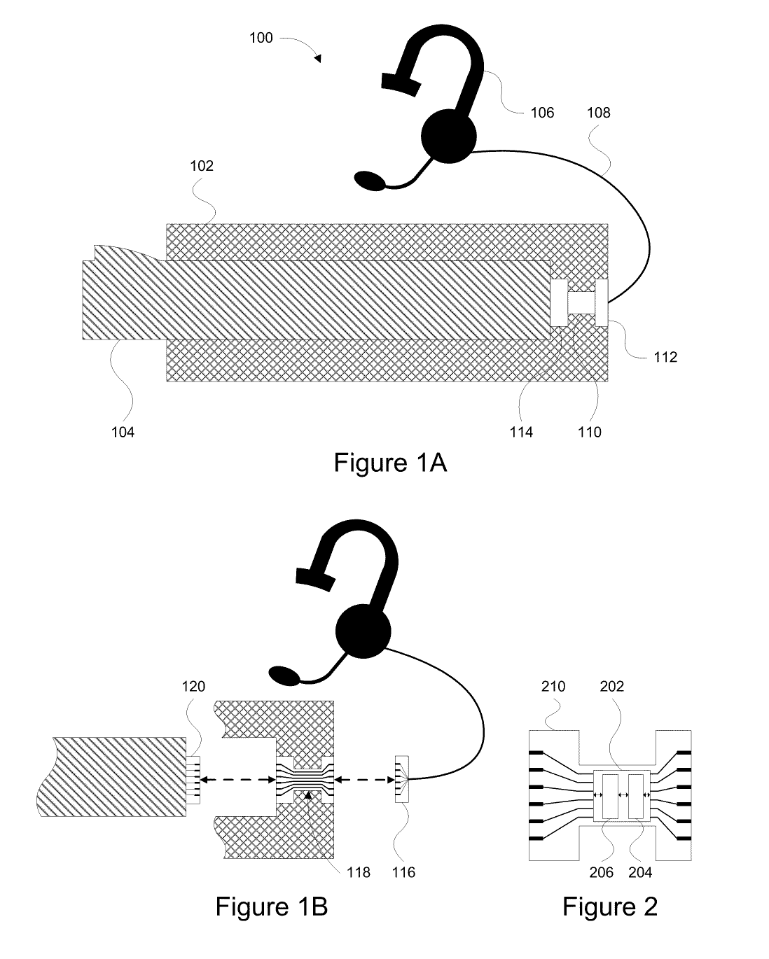

FIG. 1A depicts a schematic of an illustrative speech-controlled mobile computer system 100. The system 100 comprises a wearable holder 102 that is designed to cradle mobile computer 104. The mobile computer 104 includes speech input and output capabilities for speech-directed operations. A headset 106 that may include an audio output device such as headphones, an audio input device such as a microphone or both is used in order to make use of the speech-directed operations of the mobile computer 104. The wearable holder 102 may be holster worn on an operator's belt or may be another suitable wearable holder such as a garment pocket or backpack pouch. The wearable holder 102 may also be located anywhere on the person of the operator that is convenient for a particular mobile computer 104. A holster strapped to a thigh or a pocket located on a garment forearm are two illustrative examples of locations that might be suitable for particular handheld device.

The wearable holder 102 includes a connection adapter 110 that establishes a communication path between the headset 106 and the mobile computer 104. The headset 106 is physically connected to the connection adapter 110 by a cable 108. The headset 106 may include a microphone and an earphone, although headset may be replaced with many possible variations such as a lapel mounted microphone and headphones or speakers. Furthermore, the headset 106 may only comprise the headphones or the microphone. The headset cable 108 incorporates an electrical connector 116 for making an electrical connection to a corresponding headset connection jack 112 of the headset connection adapter 110. The headset connection jack 112 may be incorporated into the headset connection adapter 110 or it may be located within, or affixed to, the wearable holder 102 and physically connected to the headset connection adapter 110. The headset connection jack 112, and the corresponding headset electrical connector 116, may be chosen to comply with many different electrical connector types. Although a releasable headset connection jack 112 and electrical connector 116 are depicted in FIGS. 1A and 1B a permanent connection could also be employed to make the connection from the headset cable 108 to the headset adapter 110, although in practice the ability to easily change headsets is often desirable for hygienic, or replacement reasons.

In addition to the headset connector jack 112, the headset connection adapter 110 further comprises a docking connector 114 for establishing a communication link between the mobile computer 104 and the headset connection adapter 110. When the mobile computer 104 is seated in the wearable holder 102, a corresponding docking connector120 on the mobile computer 104 engages with the docking connector 114 of the headset connection adapter 110, establishing an electrical path for the communication link. The headset connection adapter 110 establishes a path between the electrical paths of the headset connector jack 112 and the docking connector 114.

The headset connection adapter 110 establishes a communication path between the mobile computer, when seated in the wearable holder 102, and the headset 106, when physically connected to the headset 106. The communication path may be establishes by a plurality of wires or electrical connections 118 of the headset connection adapter 110 that connect the corresponding electrical connections of the headset connector jack 112 with those of the of docking connector 114. When the mobile computer 104 is seated in the wearable holder 102 the communication path between the mobile computer 104 and the headset 106 is established over the electrical wires or connections 118 of the headset connection adapter 110.

While an operator is wearing the wearable holder 102, the headset 106 can remain physically connected to the headset connection adapter 110 of the wearable holder 102. An advantage of this arrangement is that the cable 108 connecting the headset 106 to the headset connection adapter 110 can be routed between the two components before the operator begins working and does not need to move significantly until the operator no longer requires the use of the mobile computer 104. Routing the headset cable 108 in this fashion does not require additional length to provide the operator freedom to move and operate the mobile computer 104. Removing the mobile computer 104 from the holder 102 for operation does not pull the headset 102 out of position or pull on any other possible connection point affixed to the operator such as a reel or coil since the headset is connected to the wearable holder 102 and not the mobile computer 104. Accordingly the headset cable 108 is not likely to become entangled with itself or anything within the work environment as the operator proceeds to perform his or her tasks. Furthermore, the cable 108 and the connection between the headset electrical connector 116 and the headset connector jack 112 is not stressed during operation of the mobile computer 104 and in particular when the mobile computer is removed from the wearable holder 102, reducing the possibility of breakage of the headset connection jack 112, headset electrical connector 116 and the cable 108.

The wearable holder 102 includes a docking connector 114 for establishing a connection between the mobile computer 104 and the headset adapter 110. The docking connector 114 is depicted as a physical male/female type electrical connection. A male docking connector 120 is located on the mobile computer 104 and a corresponding female docking connector 114 is located on or in the wearable holder 102. It will be appreciated that the specific connector type used for establishing the connection between the mobile computer 102 and the headset connection adapter 110 may be implemented in various ways. The docking connector 114 of the headset adapter 110 and the corresponding docking connector 120 of the mobile computer 104 allows for the quick connection and disconnection of the mobile computer 102 to and from the headset adapter 110, which in turns allows for the establishment, disconnection and re-establishment of the communication path between the mobile computer 102 and the headset 106. If a physical connection is established between the headset 106 and the headset adapter 110 as well as between the mobile computer 102 and the headset adapter, the headset 106 may be powered from the power source of the mobile computer. This can reduce the need of an additional headset battery, reducing both the weight, cost and complexity.

While the mobile computer 102 is seated within the wearable holder 102 such as a holster, the operator may receive voice instructions or other information from the mobile computer 102. Additionally or alternatively the operator may use speech input for controlling the mobile computer 104. While the mobile computer 104 is removed from the wearable holder 102 the operator is able to freely operate the mobile computer 104 for scanning bar codes, entering data, viewing output or other tasks requiring movement of the mobile computer 104. Advantageously, there are no cables connected to the mobile computer 104 when it is removed from the wearable holder 102. A communication path between the headset 106 and the mobile computer 102 is re-established once the mobile computer 102 is returned to the wearable holder 102.

FIG. 2 depicts in a block diagram another illustrative headset connection adapter 210. The headset connection adapter 210 provides the same functionality as described above with respect to the headset connection adapter 110; however, it further includes at least one electrical circuit 202 located between the headset connector jack 112 and the docking connector 114. The electrical circuit 202 may perform various functions such as processing the electrical signals of the communication path. The electrical circuit 202 may include a rechargeable battery for providing the required power to the electrical circuit 202. The battery may be recharged through the docking connector 114 when the mobile computer is seated in the wearable holder 102. The processing performed by the electrical circuit 202 may include enhancing the audio characteristics of the electrical signals. Additionally or alternatively, the electrical circuit 202 may perform different functions as described further below.

The electrical circuit 202 may include a memory buffer 204 that temporarily stores the information received from the headset 106 when the mobile computer 104 is not seated in the wearable holder 102, and so there is no communication path between the headset 106 and the mobile computer 104. If the electrical circuit 202 includes the memory buffer 204, it may also include connection control circuitry 206. The connection control circuitry 206 may be configured to detect when the mobile computer 104 is seated in the wearable holder 102 and provide the information stored in the memory buffer 204 to the mobile computer 104 once the communication path is re-established, as well as provide any information to or from the headset when the communication path is established.

Although the use of a memory buffer 204 and connection control circuitry 206 makes the headset connection adapter more complex, it may provide a better user experience for the operator since the operator may begin issuing the next speech command as the mobile computer 104 is being placed back in the wearable holder 102, but prior to the mobile computer's docking connector 120 fully engaging with the docking connector 114 of the headset connection adapter 210. The speech command will be stored temporarily in the memory buffer 204 until the communication link with the mobile computer 104 is re-established. Once the communication link is re-established, the connection control circuitry can send the information stored in the memory buffer 204 to the mobile computer 104 for processing

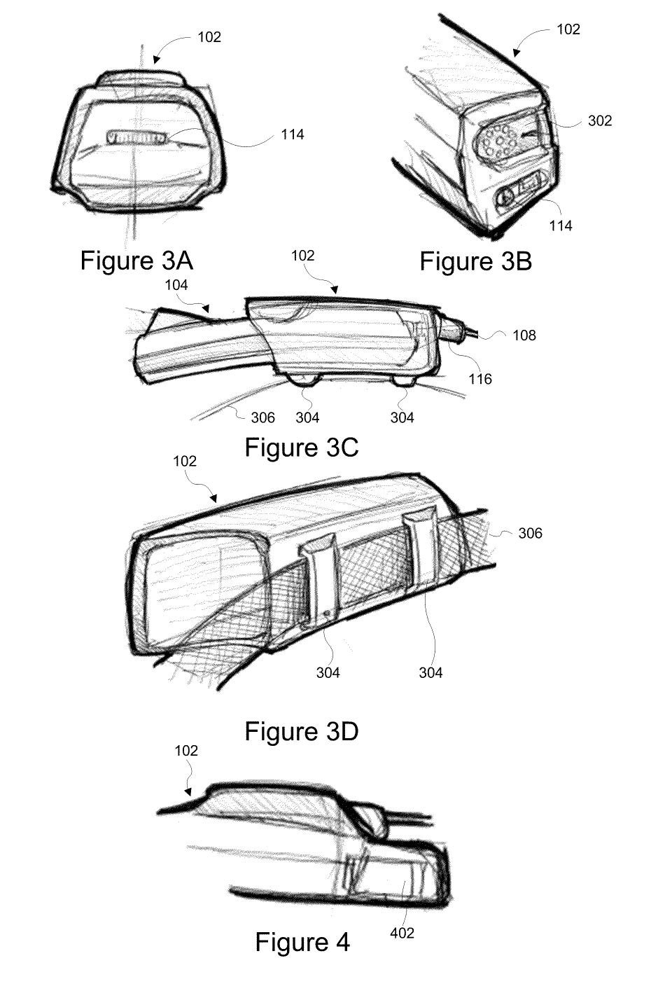

FIGS. 3A-3D depict in schematics an illustrative embodiment of the wearable holder 102. The wearable holder 102 of FIGS. 3A-3B has a housing that defines an interior space for holding the mobile computer 104. The housing may be made from various materials, such as metal plastic, cloth, webbing or a combination thereof. The headset connection adapter 110 may be include as an integral component of the housing, or it may be formed separately from the housing and secured or affixed to it in various ways. At a bottom of the interior space there is located a docking connector 114. When the mobile computer is placed in the wearable holder 102, the corresponding docking connector on the mobile computer 104 engages with the docking connector 114 of the wearable holder, establishing an electrical connection and a communication link to the headset connection adapter. A headset connector jack 112 is located on an bottom of the exterior of the housing. One of ordinary skill in the art will appreciate that the headset connector jack may use any physical form appropriate or desirable for establishing a communication link between the headset connection adapter and the headset. The headset connector jack 112 is electrically coupled, either directly or indirectly through a circuit, to the docking connector 114 as described above. A cable 108 of a headset (not shown) may include a corresponding electrical connector 116 for physically and electrically coupling the headset to the headset connector jack 112. The headset electrical connector may include a catch mechanism for releasably securing the headset's connection to the headset connector jack in order to ensure an electrical connection is maintained.

In addition to the headset connector jack 112, there may also be additional connection ports 302, such as a universal serial bus (USB) port or other types of ports as desired. Similar to the headset connector jack 112, the additional ports 302 may also be electrically connected to the docking connector 114 in order to establish a communication path between a peripheral connected to the additional port 302 and the mobile computer 104 when seated in the wearable holder 102.

The wearable holder may include belt clips or loops 304 in order to secure the wearable holder to a belt 306 of the operator. It will be appreciated that many other means for securing the wearable holder 102 to the operator are possible. Additionally, the wearable holder may form part of a garment for the worker, and as such would not need to be secured to the operator separately.

The housing of the wearable holder 102 may include a release mechanism in order to secure the mobile computer 104 within the wearable holder 102 and ensure that the connection to the docking connector 114 is maintained. The release mechanism may comprise a friction fit between the housing and the mobile computer, a releasable latch mechanism, or other means for securing the mobile computer within the wearable holder.

FIG. 4 depicts in a schematic an alternative embodiment to the wearable holder 102 of FIGS. 3A-3B. In addition to the elements of the wearable holder 102 described above the illustrative wearable holder of FIG. 4 may include an external holder 402 for holding a spare battery or other accessories.

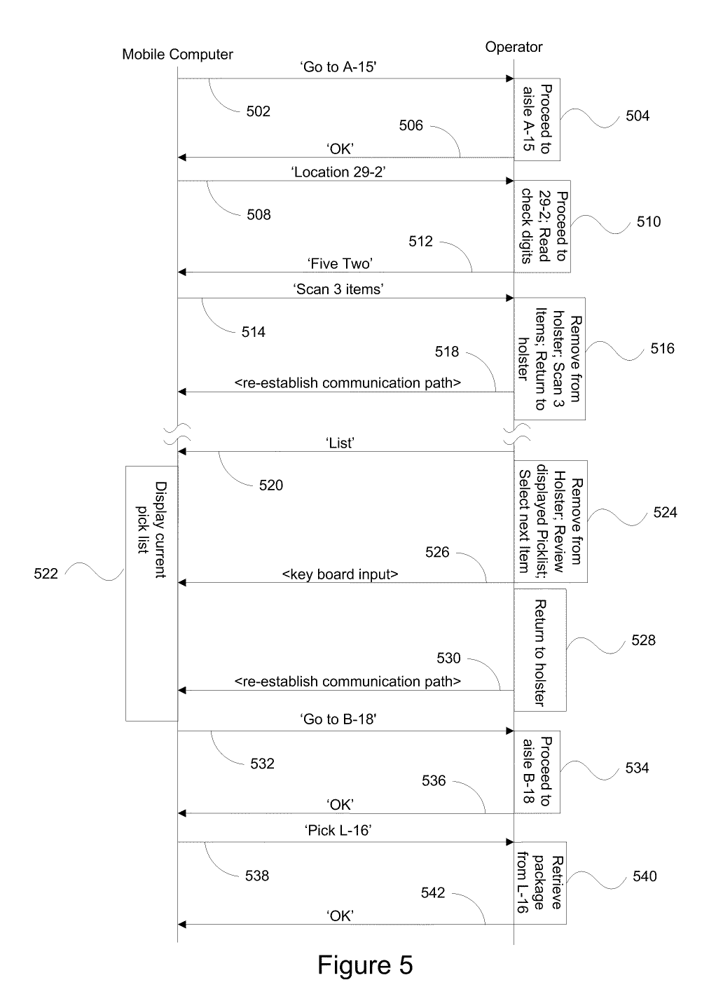

FIG. 5 depicts in a process flow chart the use of the voice controlled mobile computer system described herein. The process of FIG. 5 is assumed to be carried out within a warehouse environment, where an operator is directed to carry out various tasks such as scanning certain items, and retrieving items from a ‘pick list’. The process begins with the mobile computer seated in the wearable holder and the headset connected to the wearable holder. The mobile computer issues a voice command directing the operator to proceed to aisle A-15 (502). The operator proceeds to aisle A-15 (504) and once there issues a voice command to the mobile computer indicating that the action has been carried out (506). The mobile computer issues another voice command directing the operator to a specific location in the aisle (508). The operator proceeds to the location (510) and reads check digits from the location (512). The check digits are used to ensure that the operator is in the correct location. Assuming that the check digits are correct, the mobile computer then issues another voice command directing the operator to scan 3 items from the location (514). The operator removes the mobile computer from the holster, breaking the communication path between the headset and the mobile computer, scans 3 items from the location using the mobile computer as a handheld scanner, and then returns the mobile computer to the holster (516) which re-establishes the communication path between the headset and the mobile computer (518).

At a later time, with the mobile computer still seated in the wearable holder, the operator may issue another voice command instructing the mobile computer to display a list of the current ‘pick list’ (520). The mobile computer displays the current pick list on the display (522). After issuing the command, the operator removes the mobile computer from the wearable holder in order to review the displayed pick list (524). The operator may use the keyboard of the mobile computer in order to select another item to retrieve (526). After using the keyboard to select the next item, the operator returns the mobile computer to the wearable holder (528), which re-establishes the communication path between the mobile computer and the headset (530). The mobile computer can issue speech commands to instruct the operator to proceed to the next location (532). The operator proceeds to the specified location (534) and indicates to the mobile computer that the action has been carried out (536). The mobile computer may then issue a speech command instructing the operator to retrieve an item from a specified location (538). The operator can retrieve the package from the location (540) and issue a speech command to the mobile computer indicating that the action has been completed (542).

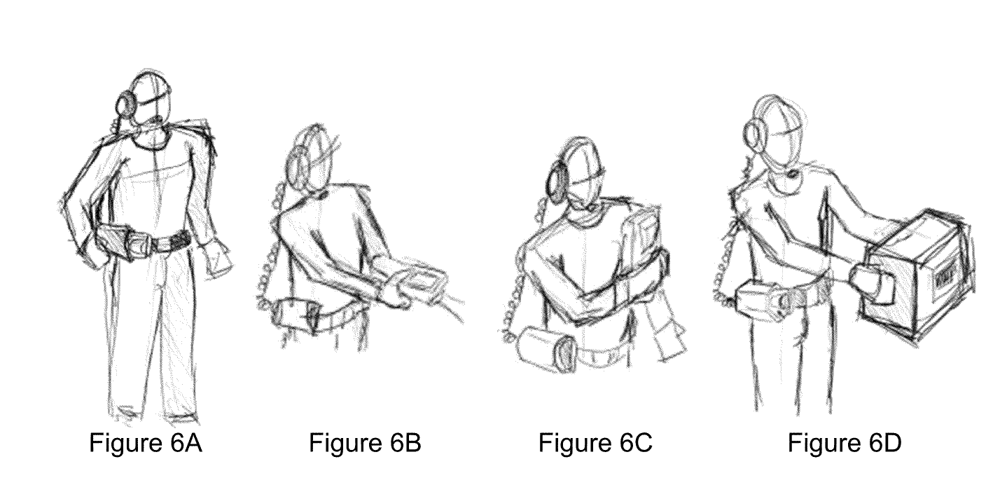

FIGS. 6A-6D depict schematics of an operator using the voice controlled mobile computing system. FIG. 6A depicts the operator proceeding to an aisle as directed by a voice command received from the mobile computer, which is seated within the wearable holder. This may correspond to steps 502-512 and 532-536 described above. FIG. 6B depicts the operator using the mobile computer removed from the wearable holder in order to scan an item, such as in step 516 described above. FIG. 6C depicts the operator reviewing the display screen of the mobile computer, which is removed from the wearable holder. This may correspond to steps 538-542 described above.

It will be appreciated that the above process described above with reference to FIGS. 5 and 6A-6D are intended to be illustrative only. The system may be advantageously used in any environment in which a headset is connected to a mobile computer that is frequently removed from a holder or holster. The described system allows a user to take advantage of speech directed operations using a wired headset without the disadvantages created by a physical link directly to the mobile computer.

Although the above has described that the docking connector 114 of the headset adapter 110 and the docking connector 120 of the mobile computer 104 provide a physical connection, it will be appreciated that other types of connections between the headset adapter 110 of the wearable holder 102 and the mobile computer 102 are possible. For example, this connection may be made using a variety of other means such as an infrared or radio frequency transmitter/receiver combination or another type of electrical connection. If a wireless type connector is used to establish the communication path between the mobile computer 104 and the headset adapter 110, the wearable holder 102 may be provided with a power source for powering both the wireless connection and the headset 106.

It will be appreciated that the wearable holder does not need to enclose a portion of the mobile computer in order for the mobile computer to be cradled by the wearable holder. Although not depicted in the figures, it is possible for holder and connection adapter to be provided in a clip or other similar holder to which the mobile computer is releasable secured. Although the above description has referred to the mobile computer as being seated in, cradled or held in the holder, it will be appreciated that these terms are to be understood to broadly incorporate any means in which the mobile computer is secured to the connection adapter, or a component the connection adapter is part of or affixed to, in such a manner that a communication link may be established between the mobile computer and the connection adapter.

Furthermore, although the above description has described various embodiments in which a headset is used in conjunction with a mobile computer, those of ordinary skill in the art will appreciate that the same solution may be used for physically connecting various peripherals to a mobile computer that can be operated while in a holder as well as when removed from the holder. One of ordinary skill in the art will appreciate that the headset described above with respect to the various embodiments may be replaced by different input and/or output devices.

One or more illustrative embodiments have been described by way of example. It will be apparent to persons skilled in the art that a number of variations and modifications can be made without departing from the scope of the invention as defined in the claims.

What is claimed is:

1. An apparatus for creating a communication link between an input and/or output (I/O) device and a mobile computer, the apparatus comprising:
a wearable holder for cradling the mobile computer; and
a connection adapter coupled to the wearable holder, the connection adapter comprising:
a docking connector for creating a first communication link between the connection adapter and the mobile computer; and
a connector jack for establishing a physical connection to the I/O device, the physical connection providing a second communication link between the connection adapter and the I/O device;
wherein a communication path may be established between the mobile computer when cradled by the wearable holder and the I/O device over the first and second communication links.

2. The apparatus of claim 1 wherein the docking connector is an electrical docking connector and the communication link between the connection adapter and the mobile computer is created by physically engaging the docking connector with a corresponding connector on the mobile computer.

3. The apparatus of claim 1 wherein the I/O device comprises a headset including a speaker and microphone and wherein the connector jack is a headset adapter for receiving a connector coupled to a cable of the headset.

4. The apparatus of claim 3 wherein the connection adapter establishes the communication path between mobile computer and the I/O device by electrically connecting the electrical docking connector with the headset adapter, whereby an electrical path is established between the corresponding connector on the mobile computer and the headset when the mobile computer is cradled by the wearable holster and the headset is connected to the headset adapter.

5. The apparatus of claim 1 wherein the connector jack is physically connected to an adapter for receiving a connector coupled to a cable of the I/O device and wherein the adapter is affixed to the wearable holder.

6. The apparatus of claim 1 wherein the wearable holder is a holster.

7. The apparatus of claim 5, wherein the holster comprises a release mechanism for releasably securing the mobile computer within the wearable holder when the mobile computer is cradled by the wearable holder.

8. The apparatus of claim 1, wherein the connection adapter further comprises an electronic circuit coupling the docking connector to the connector jack for processing information received at the connection adapter from the docking connector and/or the connector jack.

9. The apparatus of claim 8, wherein the electronic circuit comprises a buffer circuit for temporarily storing information received from the connector jack when the communication link with the mobile computer is not established, the electronic circuit further for providing the stored information to the mobile computer when the communication link to the mobile computer is re-established with the docking connector.

10. A voice controlled mobile computer system comprising:
a mobile computer adapted for optically capturing information, processing captured information and providing voice commands to an operator;
a headset comprising a cable with a connector at a terminal end and a speaker, the headset capable of outputting the voice commands to the operator; and
a wearable holder for cradling the mobile computer, the wearable holder comprising:
a connection adapter coupled to the wearable holder, the connection adapter comprising:
a docking connector for creating a communication link between the connection adapter and the mobile computer; and
a connector jack for receiving the connector attached to the cable of the headset and establishing a physical connection to the headset, the physical connection providing a communication link between the connection adapter and the I/O device;
wherein the headphones remain connected to the connector jack when the mobile computer is removed from the wearable holder and a communication path is established between the mobile computer and the headset when the mobile computer is cradled by the wearable holder.

11. The voice controlled mobile computer system as claimed in claim 10, wherein the docking connector is an electrical docking connector and the communication link between the connection adapter and the mobile computer is created by physically engaging the docking connector with a corresponding connector on the mobile computer.

12. The voice controlled mobile computer system as claimed in claim 10 wherein the headset further comprises a microphone and the mobile computer is further adapted for processing voice commands received from the microphone of the headset.

13. The voice controlled mobile computer system as claimed in claim 10, wherein the connection adapter establishes the communication path between mobile computer and the headset by electrically connecting the docking connector with the headset adapter, whereby an electrical path is established between the corresponding connector on the mobile computer and the headset when the mobile computer is cradled by the wearable holster and the headset is connected to the headset adapter.

14. The voice controlled mobile computer system as claimed in claim 10, wherein the connector jack is physically connected to an adapter for receiving a connector coupled to a cable of the I/O device and wherein the adapter is affixed to the wearable holder.

15. The voice controlled mobile computer system as claimed in claim 10 wherein the wearable holder is a holster.

16. The voice controlled mobile computer system as claimed in claim 10, wherein the holster comprises a release mechanism for releasably securing the mobile computer within the wearable holder when the mobile computer is cradled by the wearable holder.

17. The voice controlled mobile computer system as claimed in claim 10, wherein the connection adapter further comprises an electronic circuit coupling the docking connector to the connector jack for processing information received at the connection adapter from the docking connector and/or the connector jack.

18. The voice controlled mobile computer system as claimed in claim 17, wherein the electronic circuit comprises a buffer circuit for temporarily storing information received from the connector jack when the communication link with the mobile computer is not established, the electronic circuit further for providing the stored information to the mobile computer when the communication link to the mobile computer is re-established with the docking connector.

19. A connection adapter for use with a wearable holder for establishing a communication path between a mobile computer and an Input and/or Output (I/O) device, the connection adapter comprising:
a docking connector for creating a communication link between the connection adapter and the mobile computer; and
a connector jack for receiving the connector attached to the cable of the headset and establishing a physical connection to the headset, the physical connection providing a communication link between the connection adapter and the I/O device,
wherein a communication is established between the communication link between the connection adapter and the mobile computer and the communication link between the connection adapter and the I/O device.

20. The connection adapter as claimed in claim 19, further comprising an electronic circuit coupling the docking connector to the connector jack for processing information received at the connection adapter from the docking connector and/or the connector jack.
